(19) United States
(12) Patent Application Publication
(10) Pub. No.: US 2026/0180353 A1
(43) Pub. Date: Jun. 25, 2026

(54) MOBILE COOLING EQUIPMENT AND ITS POWER SUPPLY SYSTEM

(71) Applicant: ADATA TECHNOLOGY CO., LTD., Taipei City (TW)

(72) Inventors: TSAI MIN CHIANG, Zhubei City (TW); YU-CHENG CHIANG, New Taipei City (TW); PO-HSIEN CHEN, New Taipei City (TW); WEN LUNG CHEN, Taipei City (TW)

(21) Appl. No.: 19/002,458

(22) Filed: Dec. 26, 2024

(30) Foreign Application Priority Data
Dec. 25, 2024 (TW) 113150771

(51) Int. Cl. H02J 7/00; F25D 29/00

(52) U.S. Cl. CPC H02J 7/933; F25D 29/003; F25D 29/006; H02J 7/64; F25D 2300/00; H02J 2207/20

(57) ABSTRACT

A mobile cooling equipment and its power supply system are disclosed. The power supply system includes a power conversion unit, an isolation unit, a control unit, and a main power supply unit. The power conversion unit is to convert AC power input from an AC input terminal into DC power and output it from a DC output terminal. The isolation unit has an electrically isolated input terminal and multiple output terminals, and it is used to transmit DC power to these output terminals. The control unit is electrically connected to the isolation unit to control the transmission of DC power from the input terminal to the output terminals via electromagnetic coupling. The main power supply unit is electrically connected to a rechargeable battery and one of the output terminals of the isolation unit, and it outputs a boosted power supply to charge the rechargeable battery containing lithium metal.

### FIELD OF THE INVENTION

The present invention relates to cooling equipment, particularly mobile cooling equipment and its power supply system.

### BACKGROUND OF THE INVENTION

With the popularization of outdoor activities, mobile refrigerators play an indispensable role in preserving fresh food or beverages. In such products, lithium batteries are often used as the power source, but lithium batteries also require a power converter (power converter) to convert external power into a suitable power supply of the lithium battery, so as to supply power to the mobile refrigerators.

In conventional power converter designs, digital control circuits (also known as digital power supplies) have become increasingly popular due to their programmability. However, these converters have some defects, including problems such as non-real-time response, poor control accuracy, and non-electrical isolation design.

Further, when a digital power supply is used to supply power to a lithium battery, the control circuit may be limited by the processing speed of the microcontroller (MCU), which is likely to cause delays due to non-real-time response in the process of supplying power, thereby affecting the efficiency. Moreover, due to the complexity and difficulty in adjusting the digital control circuit, the control accuracy may be insufficient, affecting the precision and stability of the power supply of the lithium battery. Additionally, the typical non-electrical isolation design of digital power supplies in the prior art is likely to cause electromagnetic interference, thus affecting the stability and safety of the entire system.

The above defects limit the performance and reliability of digital power supplies in lithium battery power applications. Therefore, to resolve the above problems, providing mobile cooling equipment and its power supply system is one of the important current subjects.

### SUMMARY OF THE INVENTION

In view of the above, the present invention provides mobile cooling equipment and its power supply system that can improve the power supply efficiency, stability, and safety.

To achieve the above objective, the present invention provides the power supply system of the cooling equipment, including a power conversion unit, an isolation unit, a control unit, and a main power supply unit. The power conversion unit has an AC input terminal and a DC output terminal and is configured to convert AC power input from the AC input terminal into DC power output from the DC output terminal. The isolation unit has an input terminal and multiple output terminals that are isolated electrically. The input terminal is electrically connected to the DC output terminal, so as to transmit the DC power to the output terminals. The control unit is electrically connected to the isolation unit to control the transmission of DC power from the input terminal to the output terminals via electromagnetic coupling. The main power supply unit is electrically connected to both a rechargeable battery and a first output terminal among the output terminals of the isolation unit, and outputs a boosted power supply to supply power to the rechargeable battery, where the rechargeable battery is a battery containing lithium metal.

In an embodiment of the present invention, the power supply system further includes an auxiliary power supply unit that is electrically connected to a third output terminal of the isolation unit and outputs a bucked power supply based on the DC power output from the isolation unit.

In an embodiment of the present invention, the power supply system further includes a feedback unit that is electrically connected to both the main power supply unit and the auxiliary power supply unit. The feedback unit generates a detection signal based on the boosted power supply and the bucked power supply, and transmits the detection signal to the control unit.

In an embodiment of the present invention, the power supply system further includes an overvoltage protection unit that is electrically connected to both the control unit and a fourth output terminal among the output terminals of the isolation unit, and outputs a protection signal to the control unit when the boosted power supply output from the main power supply unit exceeds a default value.

In an embodiment of the present invention, the power supply system further includes a surge absorption unit that is electrically connected between the control unit and the input terminal of the isolation unit to absorb a surge voltage or a surge current.

In an embodiment of the present invention, the power supply system further includes a shielding unit that covers part of a periphery of the power supply system and is electrically connected to a grounding terminal of the control unit.

In addition, to achieve the above objective, the present invention also provides the mobile cooling equipment, including a body, a power supply system, and a refrigeration system. The body has a box and a cover. The box has a first space and a second space, and the cover is tightly fitted to an opening of the box to form a refrigerated space. The power supply system includes a power conversion unit, an isolation unit, a control unit, and a main power supply unit. The power conversion unit has an AC input terminal and a DC output terminal and is configured to convert AC power input from the AC input terminal into DC power output from the DC output terminal. The isolation unit has an input terminal and multiple output terminals that are isolated electrically. The input terminal is electrically connected to the DC output terminal, so as to transmit the DC power to the output terminals. The control unit is electrically connected to the isolation unit to control the transmission of DC power from the input terminal to the output terminals via electromagnetic coupling. The main power supply unit is electrically connected to both a rechargeable battery and a first output terminal among the output terminals of the isolation unit, and outputs a boosted power supply to supply power to the rechargeable battery, where the rechargeable battery is a battery containing lithium metal. The refrigeration system is disposed in the second space and driven by the rechargeable battery to adjust a temperature of the refrigerated space.

As mentioned above, according to the mobile cooling equipment and its power supply system of the present invention, an input side and an output side of the isolation unit are isolated electrically, avoiding electromagnetic interference between the input side and the output side, thereby enhancing the safety protection level and the power supply performance of the lithium battery power supply.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a mobile cooling system according to a preferred embodiment of the present invention.

FIG. 2 is a schematic diagram of a block of a power supply system of the mobile cooling system according to a preferred embodiment of the present invention.

### DETAILED DESCRIPTION OF PREFERRED EMBODIMENTS

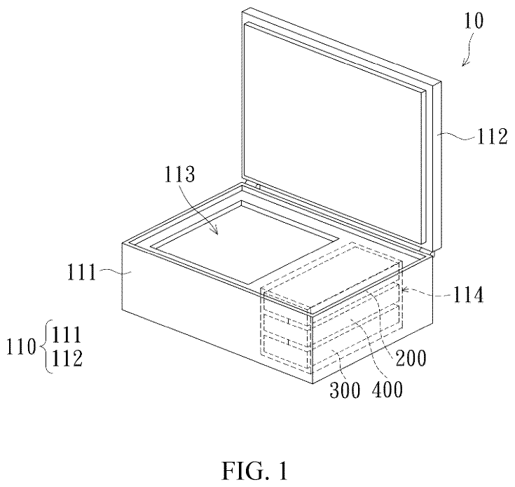

Referring to FIG. 1, a preferred embodiment of the present invention provides mobile cooling equipment 10, including a body 110, a power supply system 200, a refrigeration system 300, and a rechargeable battery 400. The mobile cooling equipment 10, such as a mobile refrigerator, may include a small refrigerator for outdoor activities or a cooler or freezer mounted on a motorcycle or truck for transporting goods, depending on the use.

As shown in FIG. 1, the body 110 includes a box 111 and a cover 112. The box 111 has a first space 113 and a second space 114 that are separated. The first space 113 can be used to accommodate items to be preserved, such as fresh food, while the second space 114 is used for arranging the power supply system 200, the refrigeration system 300, and the rechargeable battery 400. The cover 112 can be tightly fitted to an opening of the box 111 to form a refrigerated space. In this embodiment, the opening of the first space 113 is exposed to the outside of the box 111, so the cover 112 is tightly fitted to the opening of the first space 113.

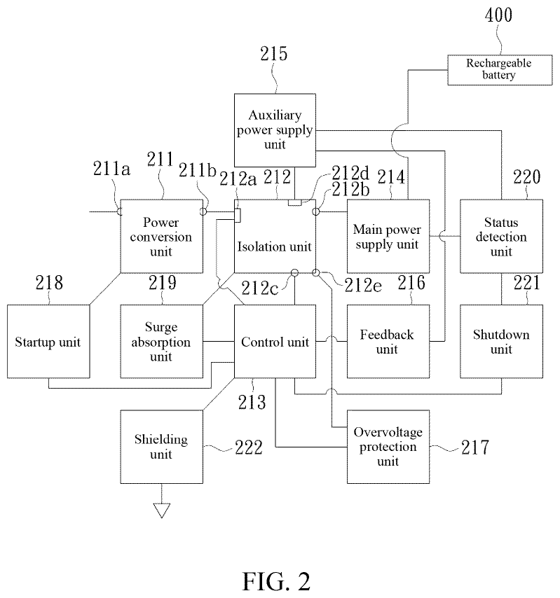

Referring to FIG. 2, the power supply system 200 includes a power conversion unit 211, an isolation unit 212, a control unit 213, a main power supply unit 214, an auxiliary power supply unit 215, a feedback unit 216, an overvoltage protection unit 217, a startup unit 218, a surge absorption unit 219, a status detection unit 220, a shutdown unit 221, and a shielding unit 222.

The power conversion unit 211 has an AC input terminal 211a and a DC output terminal 211b. The power conversion unit 211 converts AC power input from the AC input terminal 211a into DC power, which is then output from the DC output terminal 211b. The power conversion unit 211 is an AC-DC converter (AC-DC converter), also known as an adapter (adapter).

The isolation unit 212 has an input terminal 212a and multiple output terminals that are isolated electrically, where output terminals include a first output terminal 212b, a second output terminal 212c, a third output terminal 212d, and a fourth output terminal 212e. The input terminal 212a is electrically connected to the DC output terminal 211b, so as to transmit the DC power to the output terminals. In this embodiment, the isolation unit 212 includes a coupling component that transmits electrical energy from the input terminal 212a to the output terminals via electromagnetic coupling. For example, the isolation unit 212 may be, for example, an isolation transformer, having an input side winding and an output side winding that are electrically isolated, respectively with different grounding terminals.

The control unit 213 is electrically connected to both the input terminal 212a and the second output terminal 212c of the isolation unit 212 to control the transmission of DC power from the input terminal 212a to the output terminals via electromagnetic coupling. Additionally, the isolation unit 212 also provides power required by the control unit 212 via the second output terminal 212c.

The main power supply unit 214 is electrically connected to both the rechargeable battery 400 and the first output terminal 212b of the isolation unit 212. The main power supply unit 214, such as a boost circuit (boost circuit), outputs a boosted power supply to power (charge) the rechargeable battery 400 based on the DC power output from the isolation unit 212. In this embodiment, the rechargeable battery 400 is a battery containing lithium metal, including but not limited to a lithium-ion polymer battery, a ternary lithium battery, or a lithium iron phosphate battery.

The auxiliary power supply unit 215 is electrically connected to the third output terminal 212d of the isolation unit 212. The auxiliary power supply unit 215, such as a bulk circuit (bulk circuit), outputs a bucked power supply based on the DC power output from the isolation unit 212 to provide the power required by electronic devices charged via, for example, USB or TYPE-C interfaces.

The feedback unit 216 is electrically connected to both the main power supply unit 214 and the auxiliary power supply unit 215. The feedback unit 216 detects the voltage of the boosted power supply output from the main power supply unit 214, generates a detection signal for the voltage of the boosted power supply output from the main power supply unit 214 with reference to the bucked power supply provided by the auxiliary power supply unit 215, and transmits the detection signal to the control unit 213. It is worth mentioning that the control unit 213 adjusts the duty cycle of the input terminal 212a of the isolation unit 212 based on the detection signal, to change the voltage of the boosted power supply output from the main power supply unit 214.

The overvoltage protection unit 217 is electrically connected to both the control unit 213 and a fourth output terminal 212e of the isolation unit 212. The overvoltage protection unit 217 outputs a protection signal to the control unit 213 when the boosted power supply output from the main power supply unit 214 exceeds a default value, to provide overvoltage protection for the control unit 213. Overvoltage protection may be, for example, but is not limited to cutting off the power supply of the system or forcing a step-down. In this embodiment, the fourth output terminal 212e of the isolation unit 212 is in the same phase as the input terminal 212a.

The startup unit 218 is electrically connected to both the control unit 213 and the power conversion unit 211, to start the control unit 213 with the power provided by the power conversion unit 211.

The surge absorption unit 219 is electrically connected between the control unit 213 and the input terminal 212a of the isolation unit 212, to absorb surge voltage or surge current generated when the control unit 213 controls the input terminal 212a of the isolation unit 212 to transmit electrical energy via electromagnetic coupling.

The status detection unit 220 is electrically connected to both the main power supply unit 214 and the auxiliary power supply unit 215. The status detection unit 220 detects whether the output statuses of the main power supply unit 214 and the auxiliary power supply unit 215 are abnormal and feeds back related information to the control unit 213 when an abnormality is detected, so that the control unit 213 can process the abnormality.

The shutdown unit 221 is electrically connected to the status detection unit 220 to feed back related information to the control unit 213 when the output status of the main power supply unit 214 or the auxiliary power supply unit 215 is abnormal, so that the control unit 213 shuts down the main power supply unit 214 or the auxiliary power supply unit 215.

The shielding unit 222 is, for example, a conductive planar element, but is not limited to, a metal plate or metal mesh, which can cover the periphery of components in power supply system 200 that require noise isolation, and is electrically connected to the grounding terminal of control unit 213. This allows external noise or electromagnetic waves generated by the control unit 213 to be guided to the grounding terminal, thereby reducing signal noise.

Referring again to FIG. 1, the refrigeration system 300 is located in the second space 114 and close to the power supply system 200 and the rechargeable battery 400. The refrigeration system 300 may include a compressor, a drive motor, a condenser, a refrigerant controller, and an evaporator (not shown in the figure). The components of the refrigeration system 300 are interconnected using pipelines, forming a closed-loop circulation pipeline system, and the pipelines are filled with a refrigerant. Powered by the rechargeable battery 400, the compressor generates mechanical energy to continuously circulate the refrigerant within the system, thereby changing the status of the refrigerant. At high pressure, it is cooled with heat dissipated to be in a liquid state, and at low pressure, it evaporates and absorbs heat to be in a gaseous state, thus maintaining the temperature of the first space 113.

In summary, the mobile cooling equipment and its power supply system of the present invention achieve a completely independent electrical isolation state between the input side and the output side through the multi-terminal input and output design of the isolation unit. This can avoid electromagnetic interference therebetween, improve the safety protection level and the power supply performance of the lithium battery power source, and has the advantages of high safety and stable output. The overall design of the power supply system involves electrically isolated low-power analog power supplies to achieve the power output that is originally realized by high-power power supplies in the prior art, thereby providing a stable power supply for the lithium battery to ensure the lithium battery works quickly and continuously.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply system of mobile cooling equipment, comprising:
a power conversion unit that has an AC input terminal and a DC output terminal and is configured to convert AC power input from the AC input terminal into DC power output from the DC output terminal;
an isolation unit that has an input terminal and multiple output terminals, wherein the input terminal and the output terminals are electrically isolated, and the input terminal is electrically connected to the DC output terminal, so as to transmit the DC power to the output terminals;
a control unit that is electrically connected to the isolation unit to control the transmission of the DC power from the input terminal to the output terminals via electromagnetic coupling; and
a main power supply unit that is electrically connected to both a rechargeable battery and a first output terminal among the output terminals of the isolation unit, and outputs a boosted power supply to supply power to the rechargeable battery, wherein the rechargeable battery is a battery containing lithium metal.

2. The power supply system according to claim 1, further comprising an auxiliary power supply unit that is electrically connected to a third output terminal of the isolation unit and outputs a bucked power supply based on the DC power output from the isolation unit.

3. The power supply system according to claim 2, further comprising a feedback unit that is electrically connected to both the main power supply unit and the auxiliary power supply unit, wherein the feedback unit generates a detection signal based on the boosted power supply and the bucked power supply, and transmits the detection signal to the control unit.

4. The power supply system according to claim 1, further comprising:
an overvoltage protection unit that is electrically connected to both the control unit and a fourth output terminal among the output terminals of the isolation unit, and outputs a protection signal to the control unit when the boosted power supply output from the main power supply unit exceeds a default value; and
a surge absorption unit that is electrically connected between the control unit and the input terminal of the isolation unit to absorb a surge voltage or a surge current.

5. The power supply system according to claim 1, further comprising a shielding unit that covers part of a periphery of the power supply system and is electrically connected to a grounding terminal of the control unit.

6. A mobile refrigeration device, comprising:
a body, having a box and a cover, wherein the box has a first space and a second space, and the cover is tightly fitted to an opening of the box to form a refrigerated space;
a power supply system, disposed in the second space and comprising:
a power conversion unit that has an AC input terminal and a DC output terminal and is configured to convert AC power input from the AC input terminal into DC power output from the DC output terminal;
an isolation unit that has an input terminal and multiple output terminals, wherein the input terminal and the output terminals are electrically isolated, and the input terminal is electrically connected to the DC output terminal, so as to transmit the DC power to the output terminals;
a control unit that is electrically connected to the isolation unit to control the transmission of the DC power from the input terminal to the output terminals via electromagnetic coupling; and
a main power supply unit that is electrically connected to both a rechargeable battery and a first output terminal among the output terminals of the isolation unit, and outputs a boosted power supply to supply power to the rechargeable battery, wherein the rechargeable battery is a battery containing lithium metal; and
a refrigeration system that is disposed in the second space and driven by the rechargeable battery to adjust a temperature of the refrigerated space.

7. The mobile cooling equipment according to claim 6, wherein the power supply system further comprises an auxiliary power supply unit that is electrically connected to a third output terminal of the isolation unit, and that outputs a bucked power supply based on the DC power output from the isolation unit.

8. The mobile cooling equipment according to claim 7, wherein the power supply system further comprises a feedback unit that is electrically connected to both the main power supply unit and the auxiliary power supply unit, wherein the feedback unit generates a detection signal based on the boosted power supply and the bucked power supply, and transmits the detection signal to the control unit.

9. The mobile cooling equipment according to claim 6, wherein the power supply system further comprises:
an overvoltage protection unit that is electrically connected to both the control unit and a fourth output terminal among the output terminals of the isolation unit, and outputs a protection signal to the control unit when the boosted power supply output from the main power supply unit exceeds a default value; and
a surge absorption unit that is electrically connected between the control unit and the input terminal of the isolation unit to absorb a surge voltage or a surge current.

10. The mobile cooling equipment according to claim 6, wherein the power supply system further comprises a shielding unit that covers part of a periphery of the power supply system and is electrically connected to a grounding terminal of the control unit.
